(19) United States
(12) Patent Application Publication
(10) Pub. No.: US 2025/0041935 A1
(43) Pub. Date: Feb. 6, 2025

(54) METAL ADDITIVE MANUFACTURING APPARATUS AND METHODS

(71) Applicant: Auburn University, Auburn, AL (US)

(72) Inventors: Michael J. Knotts, Montgomery, AL (US); Travis Thompson, Auburn, AL (US); Allison M. Clark, Auburn, AL (US); Jack Hudon, Auburn, AL (US); Jerry Leon Knotts, Montgomery, AL (US)

(21) Appl. No.: 18/919,370

(22) Filed: Oct. 17, 2024

Related U.S. Application Data
(63) Continuation of application No. 17/525,484, filed on Nov. 12, 2021, now abandoned.
(60) Provisional application No. 63/112,749, filed on Nov. 12, 2020.
(60) Provisional application No. 63/112,798, filed on Nov. 12, 2020.
(60) Provisional application No. 63/112,839, filed on Nov. 12, 2020.

(51) Int. Cl. B22D 23/00; B22F 12/50; B33Y 30/00

(52) U.S. Cl. CPC B22D 23/003; B22F 12/50; B33Y 30/00

(57) ABSTRACT

A metal 3D printer is disclosed for fabricating metal articles by depositing molten metal onto a print bed. The metal 3D printer has a print head formed of a crucible and a nozzle. The crucible heats the molten metal and the nozzle deposits the molten metal onto the print bed. The 3D printer further includes an induction heating system to heat the print head and a heated print bed disposed below the nozzle. The metal 3D printer also comprises a computer numerically controlled (CNC) gantry configured to move the print head and the print bed relative to each other along X, Y, and Z axes. A shielding gas blower may direct a first stream of shielding gas proximate to the crucible and a second stream of shielding gas proximate to the nozzle. The feedstock for the printer may comprise a plurality of wire strands braided together. A mesh overlay may be positioned on top of the print bed.

### CROSS REFERENCE TO OTHER APPLICATIONS

This application claims the benefit of the filing of U.S. patent application Ser. No. 17/525,484, filed on Nov. 12, 2021; U.S. Provisional Patent Application No. 63/112,749 filed on Nov. 12, 2020; U.S. Provisional Patent Application No. 63/112,798 filed on Nov. 12, 2020; and U.S. Provisional Patent Application No. 63/112,839 filed on Nov. 12, 2020, which are incorporated by reference herein.

### TECHNICAL FIELD

The present disclosure generally relates to the field of additive manufacturing, also known as 3D printing. Specifically, it relates to 3D printers for manufacturing metallic articles of manufacture.

### BACKGROUND

Metal additive manufacturing, or metal 3D printing as it is commonly known, is achieved using various methods, including powder bed fusion, direct energy deposition, binder jetting, and bound powder extrusion. Each of these processes involve depositing metal powder feedstock on to a print area and heating the metal powder during or after printing to bind the metal powder into a solid metal object.

For example, powder bed fusion comprises distributing a fine layer of powder over a print area and selectively melting a cross section of the final product into the powder layer. A laser or electron beam may be used to melt the powder. The process is repeated to build the final product layer by layer. In contrast, direct energy deposition comprises simultaneously depositing metal powder and fusing the metal powder together with a laser. Direct energy deposition can be done using metal wire as the feedstock but still requires a laser to melt and fuse the feedstock into the final product.

Binder jetting comprises distributing a thin layer of metal powder over a print area and selectively spraying a binding polymer onto the metal powder to form a cross section of the final product. This process is also repeated to build the final product layer-by layer. The bound metal powder is then sintered in an oven to burn off the binding agent and fuse the layers of metal powder into the final product. Similarly, bound powder extrusion uses metal powder bound in a waxy polymer as the raw material and comprises extruding the polymer-bound metal powder to form an intermediate product. The intermediate product is then sintered to remove the polymer to fuse the metal powder to form the final product.

The existing techniques for metal 3D printing have several disadvantages. The cost of existing metal 3D printers can range from several hundred thousand for bound powder extrusion printers to over a million dollars for powder bed fusion, direct energy deposition, and binder jetting printers. The metal powder required for most existing techniques is also expensive and hazardous to handle. Further, these techniques may require long print times. Additionally, unless the printers are very large (and therefore very expensive and complex), the printers are restricted to manufacturing comparatively small articles. Although some direct energy deposition printers can use metal wire as the raw material, such direct energy deposition printers have low print resolutions. Thus, they are only used for large-scale printing and are uncommon.

For non-metal 3D printing, fusion deposition modeling is a common technique. Fusion deposition modeling comprises melting a thin thermoplastic filament, extruding the melted thermoplastic, and depositing the extrudate in a pattern. Typical fusion deposition modeling printers use resistive heating elements to melt the thermoplastic. Resistive heating elements require high amounts of energy to relative to other heating methods and can only provide heat at a limited rate.

### BRIEF SUMMARY OF THE INVENTION

In some respects the invention is directed to a print head assembly for a metal 3D printer, having a print head with a crucible for receiving and melting metal feedstock and a nozzle disposed below the crucible for depositing molten metal, and an induction heating assembly comprising a metal coil and a power source for supplying electricity to the metal coil, wherein the coil is disposed adjacent to the print head.

In other respects the invention is directed to a print head assembly for a metal 3D printer, having a print head comprising a crucible for receiving and melting metal feedstock and a nozzle disposed below the crucible for depositing molten metal, and a shielding gas system, comprising a shielding gas source and a first conduit from the shielding gas source for directing a stream of shielding gas proximate to the print head.

In other respects the invention is directed to a metal feedstock for use in a 3D printer for the manufacture of metallic articles, the feedstock having a plurality of wire strands braided together.

In other respects the invention is directed to a 3D printer for fabricating metallic articles from metal feedstock, having a print head for depositing molten metal; a print bed disposed below the nozzle; and a mesh overlay positioned on top of the print bed for receiving deposited molten metal.

These features and advantages of the present disclosure will become more fully apparent from the following description and appended claims or may be learned by the practice of the disclosure as set forth hereinafter.

### BRIEF DESCRIPTION OF THE DRAWINGS

The objects, features, and advantages of the present disclosure will become better understood regarding the following description and accompanying drawings, wherein:

FIG. 1 is a block diagram illustrating one embodiment of a metal 3D printer in accordance with the present invention.

FIG. 2 is a front top perspective view of one embodiment of a metal 3D printer in accordance with the present invention.

FIG. 3 is an enlarged perspective view of the print head of the metal 3D printer of FIG. 2.

FIG. 4 is a cross-section view of the print head of the metal 3D printer of FIG. 2.

FIG. 5 is an view of the top of the print head assembly of the metal 3D printer of FIG. 2.

FIG. 6 is a cross-sectional perspective view of braided wire feedstock for a metal 3D printer in accordance with the present invention.

FIG. 7 is a perspective view of one embodiment of the print bed of a metal 3D printer in accordance with the present invention.

FIG. 8 is a cross-sectional view of the print bed of the metal 3D printer of FIG. 7.

### DETAILED DESCRIPTION

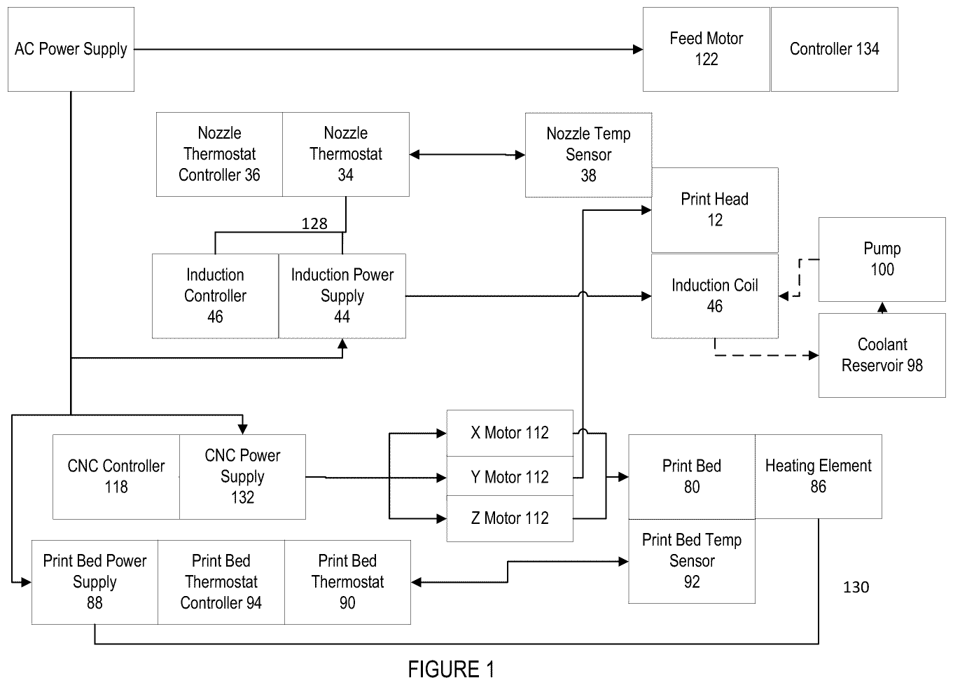

Disclosed herein is a metal 3D printer 10 utilizing extrusion and pultrusion forces to deposit semi-solid or molten metal to build a solid metal final product. FIG. 1 is a block diagram showing the connections between various components of an embodiment of a metal 3D printer 10. The metal 3D printer 10 includes a print head 12 for depositing molten metal; a pump for supplying metal to the print head 12; an induction heating system 40 for heating the metal to a molten state; a print bed 80 for receiving the metal being printed into the article of manufacture; and a computer numerically controlled (CNC) gantry, controlled by a control board, for directing the print head 12 over the print bed 80 for dispersing the molten metal in a controlled manner. In additional embodiments, the metal 3D printer 10 may also have a feeder 120 for providing metal wire or feedstock 54 to the guide and/or print head 12. In additional embodiments, the metal 3D printer 10 may have a chiller 96 or chilling system for cooling the induction heating coils 42 of the induction heating system 40. In additional embodiments, the metal 3D printer 10 may have one or more of a nozzle thermostat and temperature sensor, a print bed thermostat 90 or temperature sensor for monitoring the various systems and providing data for use in controlling the induction heating system 40, the chiller 96, the print head 12, and/or the print bed 80. In additional embodiments, the metal 3D printer 10 may have a shielding gas system 64. Not every subcomponent is present in every embodiment of the invention.

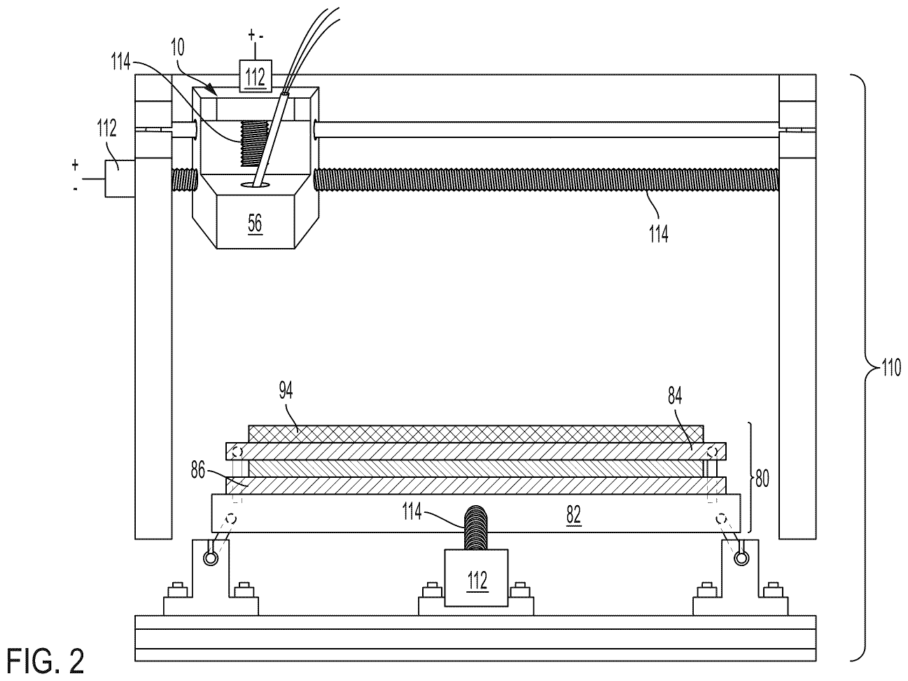

The metal 3D printer 10 has a print head 12 for depositing molten metal onto a print bed 80 or build substrate. As used herein, “melt,” “melted,” “molten,” or related terms mean heating a material to a semi-solid or fully liquified state. Also as used herein, metal may include a pure metal or a metal alloy. FIG. 2 depicts a general 3D printer assembly. Specific sections of various embodiments of such a printer assembly are discussed with reference to other figures below.

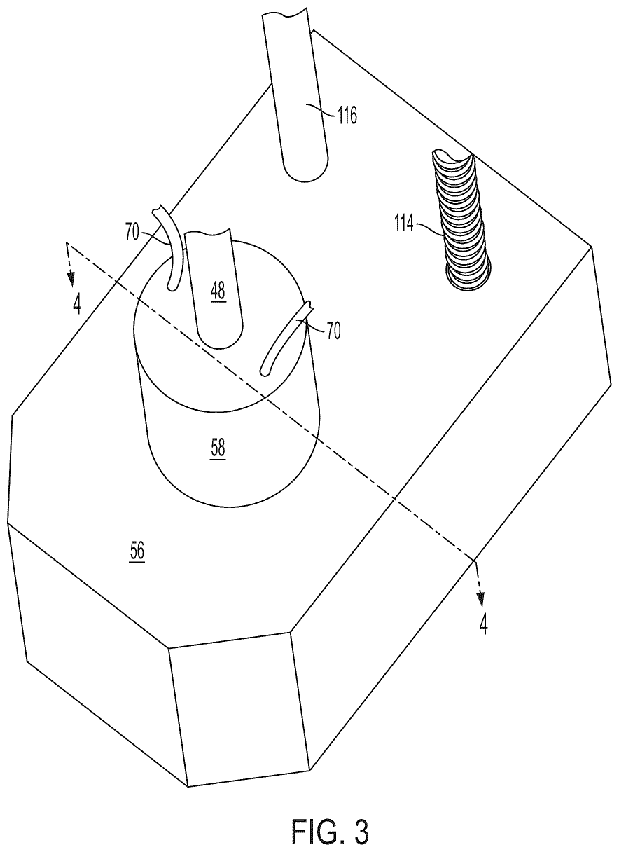

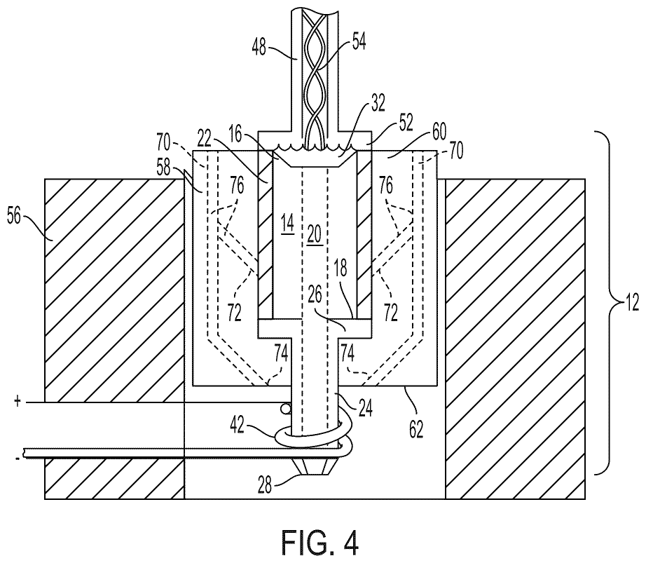

A print head 12 is shown in FIGS. 3-5. The print head 12 has a nozzle 24 placed within an induction coil 42. The print head 12 receives wire metal feedstock 54, melts the feedstock 54, and deposits the feedstock 54 to form the 3D printed object, or build. FIG. 4 shows a cross-section enlarged view of the print head 12 of the metal 3D printer 10 of FIG. 3. The print head 12 has a crucible 14 for receiving metal feedstock 54 and heating the metal to a molten state. The crucible 14 may be heated using the inducting heating system described further below. The heated metal feedstock 54 forms a small reservoir of molten metal within the crucible 14 called the melt pool 32. The crucible 14 has a top end 16, a bottom end 18, and a bore 20 extending from the top end 16 to the bottom end 18. In some embodiments, a top flange may be disposed adjacent to the crucible top end 16. The top flange may suspend the crucible 14 within an insulative housing 58, as discussed below. In other embodiments, a lower flange may be disposed adjacent the crucible bottom end 18 for the same purpose.

In some embodiments, the crucible 14 may be cylindrical in shape. Other shapes (e.g., spherical, cubed, rectangular prism, etc.) may also be used. The crucible 14 should be wide enough to support the bore 20 without being weakened by too thin walls. In some embodiments, the width of the crucible 14 may be approximately twice the width of the bore 20. The width of the upper or lower flanges may be approximately twice that of the crucible 14. For example, the bore 20 width may be 0.1875 inches when the width of the crucible 14 is 0.375 inches and the flange width is 0.75 inches. The crucible 14 may be formed of any metal having a melting point higher than the melting point of the metal feedstock 54. In some embodiments the crucible 14 may be formed of a corrosion-resistant metal, such as stainless steel, to avoid oxidation with the melt pool 32.

As shown in FIGS. 3-5, the print head 12 may further have a heating jacket 22 disposed around the crucible 14. The heating jacket 22 increases heat transfer across the crucible 14 to maintain a steady high temperature. The crucible 14 is formed of an electrically and thermally conductive material, such as carbon steel, for generating heat in response to the inductive current. For example, a stainless-steel crucible 14 may only reach 200-300 degrees Fahrenheit while a carbon steel heating jacket 22 may reach 1600 degrees Fahrenheit using the same induction coil 42. In embodiments where the crucible 14 has upper or lower flanges, the heating jacket 22 may be positioned below the upper flange or above the lower flange.

A print head nozzle 24 is disposed at the bottom end 18 of the crucible 14 to receive molten metal from the melt pool 32 and deposit the molten metal onto the print bed 80 or build substrate 94 to form the article. The nozzle 24 has a top end 26, a bottom end or outlet 28, and a bore 30 extending from the top end 26 to the bottom end 28 and aligned with the crucible bore 20. The nozzle 24 may be conical in shape and taper from the nozzle top end 26 to the nozzle bottom end 28. The nozzle bore 30 forms a deposition orifice at the nozzle bottom end 28. The nozzle 24 is may be formed of an electrically and thermally conductive material that is corrosion-resistant, similar to the crucible 14. The nozzle top end 26 is adjacent to, and may be housed within or connected to, the crucible bottom end 18. The diameter of the nozzle top end 26 may be greater than the diameter of the crucible bottom end 18 such that the nozzle top end 26 forms a flange adjacent the crucible bottom end 18. In this configuration, the heating jacket 22 may rest on the nozzle top end 26. Proper nozzle geometry minimizes oxidation and improves the melting of the feedstock 54.

In some embodiments, a nozzle thermostat 34 and sensor 38 are provided to modulate the nozzle temperature in order to heat the extrudate to a desired temperature and help produce a consistent flow. The nozzle thermostat 34 may be controlled by a programmable nozzle thermostat controller 36. A user may input a desired temperature value or range for the nozzle 24 into the nozzle thermostat controller 36. A nozzle temperature sensor 38 is disposed along the nozzle 24 to measure the nozzle temperature and communicate the nozzle temperature to the nozzle thermostat 34. The desired temperature of the nozzle 24 may be near or above the melting point of the feed metal depending on whether a semi-solid or fully liquified extrudate is desired. The nozzle thermostat 34 modulates the temperature of the nozzle 24 in response to the nozzle temperature communicated by the nozzle temperature sensor 38. The nozzle thermostat 34 may regulate the power going to the induction coil 42 or communicate with the induction controller 46 to modulate the nozzle temperature. In some embodiments, the nozzle thermostat 34 may comprise an electrical relay 128 connected between the induction coil 42 and induction power supply 44. The nozzle thermostat 34 instructs the relay 128 to either allow or block power transmission from the induction power supply 44 to the induction coil 42 depending on whether the actual nozzle temperature is below or above the desired temperature range, respectively.

The crucible 14 and nozzle 24 may be integrally formed or may be discrete pieces. Integrally forming the nozzle 24 and crucible 14 prevents molten metal from leaking at the connection between the nozzle 24 and crucible 14. On the other hand, the nozzle characteristics may be varied based on the manufacturing process, and in embodiments wherein the nozzle 24 is discrete from the crucible 14, a nozzle 24 may be exchanged as needed without also needing to attach a new crucible 14. With respect to the nozzle 24, a user may select different nozzles having different heights, diameters, or orifice sizes depending on the desired layer thickness in forming the article and/or the desired printing speed for a particular printing operation, or “print.” For example, a large nozzle may be used for a large-scale print to complete printing faster. If the crucible 14 and nozzle 24 are discrete pieces, the nozzle 24 and crucible 14 may be threaded to secure the nozzle 24 to the crucible 14.

An induction heating system 40 heats the print head 12 situated adjacent to the induction coil 42 of the induction heating system 40. As shown in FIGS. 1 and 4, The induction heating system 40 has an induction coil 42 and an induction power supply 44. The induction power supply 44 provides power to the induction coil 42. The power supply 44 may be an AC current with an isolated and regulated voltage or a DC current at a controlled frequency. The induction heating system 40 may further include an induction controller 46 connected between the induction coil 42 and induction power supply 44. The induction controller 46 may be a circuit board, integrated circuit, or other similar device for controlling a power inverter to convert AC current from the induction power supply 44 to DC current at a controlled frequency. The induction controller 46 regulates the power of the induction power supply 44 to the induction coil 42, as shown in the schematic of FIG. 1. The power may be varied according to the programming instructions of the circuit board to maintain a desired temperature of the crucible 14 and/or nozzle 24. The desired temperature of the crucible 14 and/or nozzle 24 depends on the kind of metal used as feedstock 54, as different metals or alloys have different melting temperatures.

The electrical current supplied to the induction coil 42 creates an electromagnetic field around the coil 42. The electromagnetic field creates small eddy currents within any metal object placed within the coil opening or around the coil 42. These eddy currents cause resistance heating to occur rapidly within metal items placed within or near the coil 42. Using this method, metal may be heated into a molten state.

FIG. 4 is a cross-section of a print head. The coil 42 is constructed to heat the print head 12 by virtue of the induced electromagnetic field while minimizing heating of the coil 42 itself. The induction coil 42 may have an opening in the center of the coil 42 for receiving all or part of the print head 12. By disposing the print head 12 within the coil, as shown in FIG. 4, induction heating occurs more evenly across the print head 12 as opposed to being placed outside but proximate to the coil. The induction coil 42 may be made of copper or other electrically conductive metals. In some embodiments, the induction coil 42 has a conduit disposed within the coil. For example, the coil may be a tube with the inside of the tube forming the conduit. As discussed below, a chiller 96 may pump coolant through the conduit in the induction coil 42 to cool the coil. The induction coil 42 may also be insulated to prevent heat generated in nearby objects by induction heating from transferring to the induction coil 42. Overheating of the induction coil 42 may reduce the electrical conductivity and structural integrity of the coil.

In FIG. 4, the print head 12 is partially secured in the insulative housing 58 with the bottom end 28 of the nozzle 24 exposed. The induction coil 42 is depicted as wrapped around the nozzle bottom end 28. In other embodiments, the induction coil 42 may be placed adjacent to the nozzle 24 or the print head 12 more generally. In still other embodiments, the insulative housing 58 may fully enclose the nozzle 24 except for the outlet for depositing molten metal. In such embodiments the induction coil 42 may surround or be wrapped around the insulative housing 58 and heat the metal print head 12 within the insulative housing 58. In other embodiments the induction coil 42 may be placed adjacent alongside the insulative housing 58.

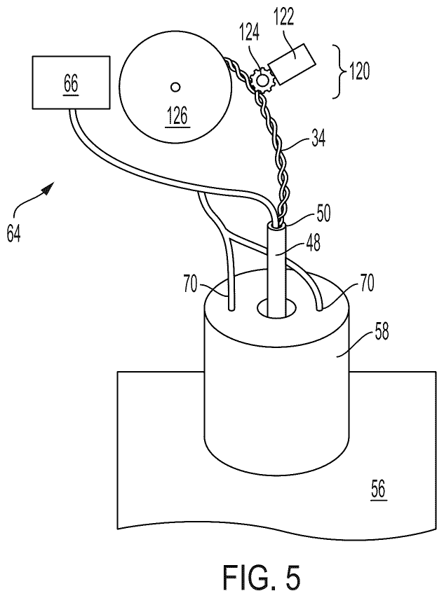

A print head guide 48 directs incoming metal feedstock 54 into the crucible 14. The guide 48 has a top end 50, a bottom end 52, and a bore extending from the top end 50 to the bottom end 52. The bore of the guide 48 is aligned with the crucible bore 20 and nozzle bore 30 when the print head 12 is assembled. The guide 48 may be cylindrical in shape. In some embodiments, the crucible 14 is threaded around the top and screws into the guide 48. In such embodiments, the diameter of the guide bottom end 52 is greater than the diameter of the crucible top end 16. Thus, the guide bottom end 52 forms a flange adjacent the crucible top end 16. Alternatively, the guide bottom end 52 may be disposed in the crucible bore 20 when the print head 12 is assembled as shown in FIG. 5. In embodiments where the guide 48 extends into the crucible 14, the guide 48 helps control the volume of the melt pool 32. The guide 48 may be made from a ceramic or metal. For example, the guide 48 may be made from alumina bisque. In addition, the guide 48 may have a port for receiving shielding gas as described further below.

The molten metal is extruded and/or drawn (pultruded) through the bore 20 from the melt pool 32 to dispersal from the nozzle 24 to be deposited on the print bed 80 and/or build substrate 94 to form the 3D-printed object. The molten metal that exits the nozzle 24 may be referred to herein as extrudate even though pultrusion forces also assist in the deposition of the molten metal. During a print, the print head 12 is disposed within or around the induction coil 42. As discussed above, a melt pool 32 is generated from the melting of metal feedstock 54. The feedstock 54 continues to be pushed down into the melt pool 32, which generates extrusion forces to push the molten metal into and through the bore 20. In addition, gravity and forces arising from surface tension generated by the deposited, cooling metal on the build generate pultrusion forces that draw the molten metal down through the bore 20. Thus, both extrusion and pultrusion forces help create a consistent flow of extrudate.

The print head 12 is secured in place within the induction coil 42 by a print head mount or mounting bracket 56, as described further below. The print head 12 may have an insulative housing 58 that retains heat within the crucible 14 and nozzle 24 while protecting the print head mount from heat of the print head 12 (i.e., the crucible 14 and nozzle 24). The insulative housing 58 at least partially surrounds the crucible 14 and/or nozzle 24 as shown in FIG. 5. The insulative housing 58 has a top end 60, a bottom end 62, and an interior surface configured to snugly enclose the crucible 14 and nozzle 24 and/or heating jacket 22. The lower end 62 may extend to the lower end or outlet of the nozzle 24, or the lower end or outlet of the nozzle may be partially exposed below the lower end of the insulative housing. The insulative housing 58 may be generally cylindrical in shape. The interior surface may have an upper segment and a lower segment. The upper segment may be shaped to snugly secure the crucible 14, while the lower segment may be shaped to snugly secure the nozzle 24. In embodiments wherein the lower segment has a smaller diameter than the upper segment, an internal flange may be created within the insulative housing 58. The upper or lower flange of the crucible 14 may rest on the insulative housing internal flange. In other embodiments, the crucible 14 and/or nozzle 24 may extend downward through the insulative housing lower segment. The insulative housing 58 may also or alternatively have an external flange around the insulative housing 58. The external flange may rest on a print head mount 56, discussed below. The insulative housing 58 is formed of a thermally insulative material. For example, the insulative housing 58 may be formed of an inorganic ceramic consisting of lime, silica, and reinforcing fibers.

In some embodiments, the 3D printer 10 may have a shielding gas system 64 for directing shielding gas to the nozzle outlet. The shielding gas promotes bonding of the extrudate to the build and reduces oxidation. The shielding gas system 64 has a shielding gas source 66 such as a pressurized tank or compressor. The shielding gas source 66 is connected by a hose or other conduit to the print head 12. The shielding gas source 66 may be directed through a pump, pressure valve, or regulator for maintaining a constant pressure and volumetric flow. Applying shielding gas to the extrudate entering the nozzle 24 helps to rapidly cool the melted feedstock 54 after it is deposited. Further, the flow of shielding gas creates a low-pressure zone around the nozzle 24. Thus, as the shielding gas flows over the nozzle 24, it creates a low-pressure zone around the nozzle 24. This low-pressure zone increases the pressure gradient across the print head 12, which helps draw the extrudate out of the nozzle 24.

Shielding gases may include, but are not limited to, argon, carbon dioxide, helium, hydrogen, nitric oxide, sulfur hexafluoride, or dichloromethane. A blend of these gases may also be used as the shielding gas. Some oxygen may be blended with the shielding gas to reduce surface tension of the molten metal. The shielding gas may be selected based on the type of metal in the feedstock 54. For example, argon gas may be used as the shielding gas when the feedstock 54 is aluminum based.

The insulative housing 58 may have a port or surface configuration to direct shielding gas provided by the shielding gas system 64 to the crucible 14 or the nozzle 24. Particularly, the shielding gas may flow to the top end of the crucible 14 and over or below the nozzle bottom end 28. FIG. 4 is a cross-sectional view of the print head 12 of a metal 3D printer 10. As shown in FIG. 4, the insulative housing 58 may have one or more gas intake ports 70 on the insulated housing top end 60, an upper gas exit port 72 in the bore upper segment, and/or a lower gas exit port 74 on the insulative housing bottom end. Gas conduits 76 connect the gas intake port(s) 70 to the gas exit port(s) 72, 74. The upper gas exit ports 72 direct shielding gas to the crucible 14. The lower gas exit ports 76 direct shielding gas to the nozzle 24 or below the nozzle 24. In some embodiments, the insulative housing 58 has two gas intake ports 70, two upper gas exit ports 72, and two lower gas exits ports 74 with each intake port 70 connecting to both an upper and lower gas exit port 72, 74.

In other embodiments, shielding gas may be directed through or along the print head guide 48 rather than or in addition to being directed through or along the insulative housing 58. As shown in FIG. 5, the guide 48 may comprise a gas intake port, a gas exit port disposed in the guide bore, and a gas conduit connecting the intake port to the exit port. The shielding gas may flow through the gas conduit from the gas intake port to the gas exit port. The shielding gas may flow down into the crucible 14 and/or insulative housing 58 and vent out of the guide top end 50. The shielding gas creates pressure within the guide 48 and the crucible 14, among other benefits. Optionally, the gas conduit is angled downward from the gas intake port to the gas exit port. The downward angle of the gas conduit helps increase the pressure within the guide 48 and the crucible 14.

The print head 12 may be secured to the CNC gantry 110 by a print head mount 56, such as a mounting bracket. In some embodiments, the print head mounting bracket 56 may have a top, a bottom, and an aperture extending from the top to the bottom as shown in FIG. 2. The insulative housing 58 is disposed in the aperture in a completed printer head assembly. An external flange of the insulative housing 58 may rest on the top of the print head mounting bracket 56 when the insulative housing 58 is disposed in the aperture. Thus, the insulated housing may be freely suspended in the print head mounting bracket 56 when the 3D printer 10 is assembled. This configuration allows for a user to easily remove and exchange the insulative housing 58. This configuration also allows the insulative housing 58 to freely expand and contract due to temperature fluctuations in the print head 12, thereby reducing damage to the print head 12, insulative housing 58, and/or print head mount 56 due to being overly constrained in a heated environment. Alternatively, the insulative housing 58 may be secured to the print head mounting bracket 56 by clamps, screws, or connection mechanisms generally known in the art. Further, the induction coil 42 may be positioned below the print head mounting bracket 56. The print head mounting bracket 56 and the insulative housing 58 may suspend the crucible 14 and nozzle 24 within or adjacent to the induction coil 42.

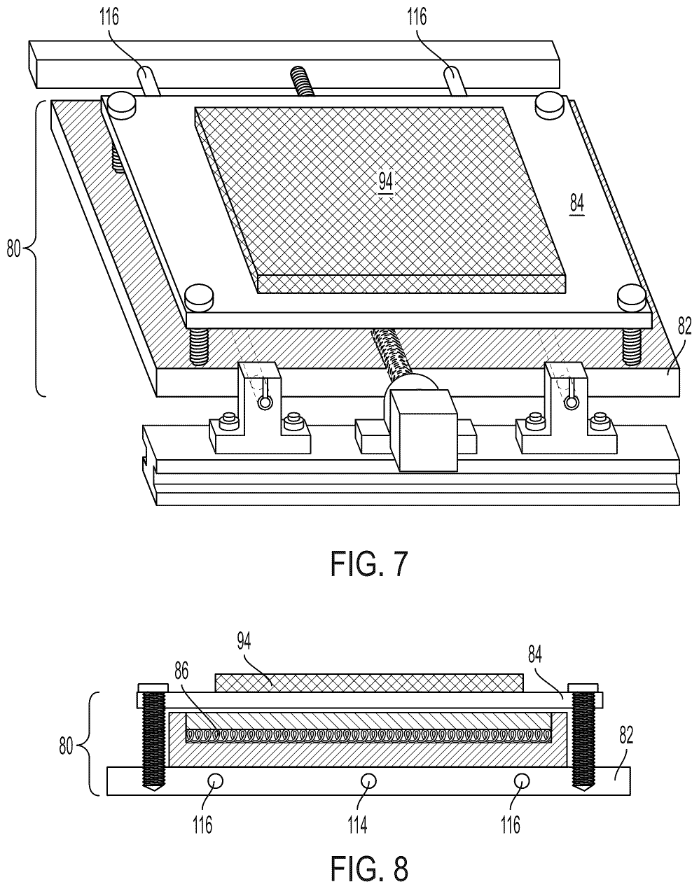

The print bed 80 is the platform onto which the print head 12 deposits the extrudate. FIGS. 7-8 show several views of one embodiment of a print bed 80. The print bed 80 comprises a base 82 and a build plate 84. In some embodiments, the print bed 80 is heated. Heating the print bed 80 reduces warping of the build as the metal in the build cools. In embodiments where the print bed 80 is heated, the print bed 80 may further comprise a heating element 86 and a print bed power supply 88 connected to the heating element 86. The heating element 86 may be disposed between the base 82 and the build plate 84, as shown in FIG. 8. The print bed 80 may heat the build plate 84 to below the melting point of the extrudate. The actual temperature will differ based on the feedstock metal used. In testing, heating the mesh overlay to between 100-400 degrees Fahrenheit below the melting point of the extrudate yielded the most geometrically accurate prints. Alternatively, the print bed 80 may heat the build plate 84 to between 50-100 degrees Fahrenheit, 50-150 degrees Fahrenheit, 100-200 degrees Fahrenheit, or 100-150 degrees Fahrenheit below the melt temperature of the extrudate.

In some embodiments, a print bed thermostat 90 and print bed temperature sensor 92 are provided to modulate the print bed temperature. The print bed thermostat 90 may be controlled by a programmable print bed thermostat controller 94. A user may input a desired temperature value or range for the print bed 80 into the print bed thermostat controller 94. A print bed temperature sensor 92 is disposed to measure the print bed temperature and communicate the print bed temperature to the print bed thermostat 90. The print bed thermostat 90 modulates the temperature of the print bed 80 in response to temperature data received from the print bed temperature sensor 92. The print bed thermostat 90 may modulate the power going to print bed heating element 86 to regulate the print bed temperature. In some embodiments, the print bed thermostat 90 may comprise an electrical relay 130 connected between the print bed heating element 86 and print bed power supply 88. The print bed thermostat 90 instructs the relay 130 to either allow or block power transmission from the print bed power supply 88 to the print bed heating element 86 depending on whether the actual nozzle temperature is below or above the desired temperature range, respectively.

The print bed base 82 is made from a thermally insulative and electrically insulative material. For example, the base 82 may be made from ceramic fiber. The print bed base 82 electrically insulates the CNC gantry 110 from the heating element 86 and thermally insulates the CNC gantry 110 from the extrudate and the heating element 86. The build plate 84 is made from a thermally conductive and electrically insulative material such as glass-ceramic. The build plate 84 conducts heat from the heating element 86 to the build while electrically insulating the build from the heating element 86.

In some embodiments, a build substrate 94 such as a metal sheet is placed on top of the build plate 84 during printing as shown in FIGS. 7-8. In such embodiments, the print head 12 deposits extrudate onto the build substrate 94 rather than directly onto the build plate 84. The build plate 84 conducts heat from the heating element 86 to the build substrate 94 while electrically insulating the build substrate 94 from the heating element 86. The build plate 84 also distributes the heat from the heating element 86 more evenly across the build substrate 94. The print bed 80, and particularly the build plate 84, should be temperature resistant to withstand the heat from the heating element 86 and the deposited metal.

In the alternative or in addition to a metal sheet build substrate 94, the build substrate 94 may be a mesh overlay having a plurality of crossing wires and apertures is placed on the build plate 84. Thus, the extrudate contacts both the mesh and the build plate 84 or the mesh and the metal sheet when the extrudate is deposited. In this manner the mesh overlay adheres to the extrudate and limits contact between the build plate 84 and the build. This configuration anchors the extrudate to the mesh overlay rather than the build plate 84.

The mesh overlay composition may be the same as or similar to the feedstock composition. The thickness of the mesh can be changed based on the extrudate thickness. The mesh wire width and the size of the mesh apertures may be changed depending on the desired contact between the build and the mesh overlay or the build and the build plate 84. During some prints, the mesh overlay may contact 35-50% of the base 82 of the print bed 80.

Before the extrudate is deposited onto the mesh overlay, the print bed 80 may heat the mesh. In some cases, the mesh is heated to near, but not above, the melting point of the metal of the mesh to prevent the mesh from degrading. When the extrudate is deposited onto the heated mesh, the heat of the extrudate partially melts the mesh. This allows the extrudate to adhere to the mesh as the extrudate cools. Adhesion between the mesh overlay and the extrudate occurs at the interfaces between the mesh overlay and extrudate. In contrast, if a solid aluminum sheet is placed on the build plate 84, the extrudate adheres to the aluminum sheet across the entire base 82 of the build. The adhesion between the mesh overlay and the build increases the geometrical accuracy of the build. For example, the mesh overlay reduces deformities at the location of arcs, corners, or sharp turns in the build within the horizontal plane of the print bed 80. This is because the mesh overlay prevents the extrudate from dragging horizontally across the build plate 84 as the print head 12 move parallel to the surface of the build plate 84.

The mesh overlay is intended to be semipermanent in that it should last through multiple prints. However, the mesh overlay may degrade over time. Serious degradation may occur when the print bed 80 exceeds the melting point of the mesh overlay material or when damage occurs from separating the mesh and the build. When damaged, the mesh may be removed and discarded. A new layer of mesh may then be placed on the build plate 84.

Placing the mesh overlay over the build plate 84 has several benefits. Less energy is required to maintain the desired temperature of the build plate 84 when the mesh overlay is used. Further, the temperature of the build plate top surface can be maintained without causing the mesh overlay to degrade. Additionally, there is better adhesion between the build and the build plate 84 as the mesh overlay removes less heat from the extrudate. Further, the build may be easily removed after the print when a mesh overlay is used. The mesh overlay also reduces the post-print processing times by making it easier to remove removing builds from the build plate 84. Accordingly, the metal 3D printer 10 can produce more builds as less time is needed between prints.

A chiller 96 circulates coolant to the induction coil 42 in order to remove heat and prevent the induction coil 42 from overheating. The chiller 96 may comprise a coolant reservoir 98, a coolant pump 100, a supply coolant hose, and a return coolant hose as shown in FIG. 1. The coolant pump 100 circulates coolant from the coolant reservoir 98 to the induction coil 42 via the supply coolant hose and back to the coolant reservoir 98 from the induction coil 42 via a return coolant hose. Excess heat is removed from the coolant in the reservoir 98 (e.g., by passing through a heat sink) before the coolant is circulated back to the induction coil 42. In some embodiments, the chiller 96 may also comprise a heat exchanger for removing heat from the coolant before recirculating the coolant back to the induction coil 42. In other embodiments, the chiller 96 does not recirculate the coolant. Rather, the coolant is only circulated through the induction coil 42 once before the coolant is disposed of. The chiller 96 may also comprise a temperature controller to modulate the temperature of the coolant as it leaves the chiller 96. The coolant may be water, ethylene glycol, or any other coolant known in the industry.

A CNC gantry 110 is used to move the print head 12 and print bed 80 relative to each other along X, Y, and Z axes, as shown in FIG. 2. In some embodiments, the print bed 80 is stationary while the CNC gantry 110 moves the print head 12 along X, Y, and Z axes. Alternatively, the print head 12 is stationary while the CNC gantry 110 moves the print bed 80 along X, Y, and Z axes. Alternatively, the CNC gantry 110 moves the print head 12 along X and Z axes and the print bed 80 along a Y axis. The CNC gantry 110 comprises a controller, a frame, and X, Y, and Z-axis motors 112. The print head 12 and print bed 80 are secured to the CNC frame. The CNC gantry 110 may also comprise guide rails extending parallel to X, Y, or Z axes. The print head 12 and/or print bed 80 may attach to the guide rails 116 and frame of the CNC gantry 110. In some embodiments, the X, Y, and Z-axis motors 112 may be stepper or servo motors. Translation screws 114, such as lead screws or ball screws, may connect the motors 112 to the print head 12 and/or print bed 80 and convert rotational movement of the motors 112 into linear movement of the print head 12 and/or print bed 80. The CNC frame may include a platform supporting the print bed 80. The print bed 80 may be releasably secured to the platform. This allows an operator to exchange or modify the print bed 80 between prints. Print beds having different areas, build plates, insulation type, and/or heating capabilities may be used depending on the build requirements

During use, the CNC controller 118 directs the movements of the print head 12 and/or print bed 80 on the CNC gantry 110. The CNC controller 118 receives instructions from a computer on how the print head 12 needs to move relative to the print bed 80. The CNC controller 118 then converts the instructions and transmits the converted instructions to the X, Y, and Z-axis motors 112. The X, Y, and Z-axis motors 112 then move the print head 12 and print bed 80 relative to each other along the X, Y, and Z axes in response to instructions from the CNC controller 118. A computer may create the instructions that are sent to the CNC controller 118 using a design program or direct input from an operator. The computer and controller 118 may be integrated in a single device. The motors may receive power from a CNC power supply 132. The CNC power supply 132 may be an AC power supply or a DC power supply or converter. Each motor may have its own power supply or converter.

In some embodiments, the 3D printer 10 may include a feeder 120 supplying feedstock 54 to the print head 12. The feeder 120 may be a wire feeder or a rod feeder. The wire feeder 120 uses spooled metal wire as the feedstock 54. As shown in FIG. 2, the wire feeder 120 comprises a feed motor 122 and one or more feed gears 124 connected to the feed motor 122. The feed gear(s) clasps the wire feedstock 54. As the feed motor 122 turns the feed gear, the feed gear pulls the wire from the wire spool 126, and directs it into the print head 12. The rod feeder 120 uses metal rods as the feedstock 54. The rod feeder 120 may comprise a hopper, a feed motor 122, and one or more feed gears 124 connected to the feed motor 122. The hopper stores the metal rod feedstock 54 and may be conical in shape. The hopper funnels the metal rod feedstock 54 to the feed gear. The feed motor 122 rotates the feed gear and directs the feedstock 54 into the print head 12. In either a rod-fed or wire-fed 3D printer 10, the feed motor 122 controls the feed rate of the feedstock 54. A computer or controller 134 may modulate the feed motor 122 and consequently the feed rate of the feedstock 54. The feed gear may also prevent the feedstock 54 from retracting out of the print head 12. To stop the deposition of the extrudate, the motor stops the insertion of feedstock 54 into the crucible 14. In some embodiments, the feeder 120 may retract the feedstock 54 from the crucible 14 to prevent pultrusion forces from drawing extrudate out of the nozzle 24 after extrusion has stopped.

Metal wire or rod feedstock 54 has some benefits over existing metal additive manufacturing processes that use metal powders as the raw material. Metal powder is a skin and eye irritant and poses a respiratory health hazard when suspended in air. Operators must use personal protective equipment such as respirators, gloves, and eye protection when handling powdered metals. The powders must be handled carefully to avoid excessive agitation of the powdered metal. The 3D printer 10 must also be sealed when the printing process is occurring to prevent the dispersal of the metal powder. Powdered metal is also often proprietary and tightly controlled by industrial protocols and government regulations, which increases the cost and decreases the amount of available information about the powder. In contrast, wire or metal feedstock 54 is typically no more dangerous than the base metal. It can be handled loosely or in spools and loaded into a feeder 120 with fewer precautions. Also, metal wire is readily available at low costs compared to powdered metal and much information about the wire is publicly available.

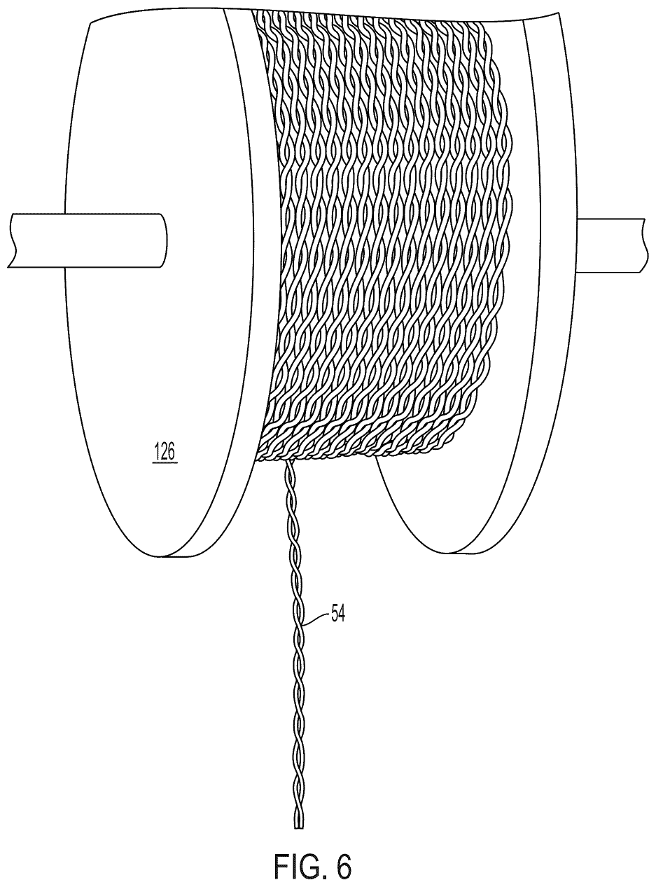

As shown in FIG. 6, the feedstock 54 may be a braided wire made from several wire strands. In some embodiments, the braided wire feedstock 54 is made from two to five smaller wire strands. The wire strands and braided wire feedstock 54 may be of various diameters. For example, the wire strands may be between 0.025 inches and 0.065 inches in diameter. Generally, the wire strands are all the same diameter and are made of the same metal or metal alloy. In some embodiments, the braided wire feedstock 54 has a nominal diameter between 0.085 inches to 0.11 inches. Alternatively, the braided wire feedstock 54 has a nominal diameter between 0.070 inches and 0.090 inches.

Braided wire feedstock 54 has several benefits. Braided wire feedstock 54 does not bend or buckle easily when heated, which helps prevent the feedstock 54 from jamming in the print head 12. However, braided wire is still flexible enough to be spooled before being fed to the print head 12. Further, the braided wire feedstock 54 has a greater surface area than a comparable single-strand wire, which increases heat transfer to and from the wire.

The shielding gas system 64 may apply shielding gas to the metal feedstock 54 before the metal feedstock 54 enters the crucible 14 and joins the melt pool 32 as shown in FIG. 5. Applying shielding gas to the incoming feedstock 54 prevents atmospheric gases from oxidizing the molten metal in the melt pool 32. Additionally, the flow of shielding gas above the melt pool 32 creates a pressure head above the melt pool 32 that prevents backflow of melted feedstock 54 and helps extrude the molten feedstock 54 from the nozzle 24. The shielding gas removes heat from the incoming feedstock 54. The heat from the crucible 14 is prone to conducting up the feedstock 54, which can weaken or cause oxidization of the incoming feedstock 54. The shielding gas reduces oxidation and the resulting weakening of the incoming feedstock 54 by convectively cooling the incoming feedstock 54.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure.

The above description of preferred embodiments should not be interpreted in a limiting manner since other variations, modifications and refinements are possible within the spirit and scope of the present disclosure. The scope of the invention(s) is defined in the appended claims and their equivalents.

What is claimed is:

1. A print head assembly for a metal 3D printer, comprising:
a print head comprising a crucible for receiving and melting metal feedstock and a nozzle disposed below the crucible for depositing molten metal; and
an induction heating assembly comprising a metal coil and a power source for supplying electricity to the metal coil, wherein the coil is disposed adjacent to the print head.

2. The 3D printer of claim 1, further comprising a print guide directing metal feedstock into the crucible.

3. The 3D printer of claim 1, further comprising an insulative housing at least partially enclosing the print head.

4. The metal 3D printer of claim 3, further comprising a heating jacket, wherein the heating jacket is disposed adjacent the crucible and is at least partially surrounded by the insulative housing.

5. The metal 3D printer of claim 4, wherein the crucible is stainless steel and the heating jacket is carbon steel.

6. The 3D printer of claim 1, further comprising:
a coolant; and
a chiller circulating the coolant through the metal coil.

7. The 3D printer of claim 6, wherein the induction heating assembly further comprises:
a heating controller;
a nozzle thermostat communicably connected to the heating controller; and
a nozzle temperature sensor communicably connected to the nozzle thermostat and disposed to measure a temperature of the nozzle,
wherein the nozzle temperature sensor communicates the nozzle temperature to the nozzle thermostat, and the nozzle thermostat instructs the heating controller to modulate the electrical power to the metal coils to modulate the nozzle temperature.

8. The 3D printer of claim 2, wherein the metal feedstock is wire feedstock, and further comprising a feeder providing the wire feedstock into the print guide.

9. The 3D printer of claim 8, wherein the metal feedstock comprises a plurality of wire strands braided together.

10. A print head assembly for a metal 3D printer, comprising:
a print head comprising a crucible for receiving and melting metal feedstock and a nozzle disposed below the crucible for depositing molten metal; and
a shielding gas system, comprising a shielding gas source and a first conduit from the shielding gas source for directing a first stream of shielding gas proximate to the print head.

11. The 3D printer of claim 10, wherein the first conduit directs the first stream of shielding gas proximate to the crucible.

12. The 3D printer of claim 11, wherein the shielding gas system further comprises a second conduit directing a second stream of shielding gas proximate to the nozzle.

13. The 3D printer of claim 10, wherein the first conduit directs the first stream of shielding gas proximate to the nozzle.

14. A metal feedstock for use in a 3D printer for the manufacture of metallic articles, comprising a plurality of wire strands braided together.

15. The metal feedstock of claim 14, wherein each of the wire strands comprising the feedstock are between 0.025 inches and 0.065 inches in diameter.

16. The metal feedstock of claim 15, wherein the feedstock is between 0.085 inches and 0.11 inches in nominal diameter.

17. A 3D printer for fabricating metallic articles from metal feedstock, comprising:
a print head for depositing molten metal;
a print bed disposed below the nozzle; and
a mesh overlay positioned on top of the print bed for receiving deposited molten metal.

18. The 3D printer of claim 17, wherein the mesh overlay is metal.

19. The 3D printer of claim 18 wherein the metal feedstock has a melting point, and the print bed is heatable to between 50 degrees Fahrenheit and 400 degrees Fahrenheit below the melting point of the metal feedstock, such that the mesh overlay partially melts and fuses to the deposited molten metal when the molten metal is deposited onto the mesh overlay.

20. The 3D printer of claim 19, wherein the mesh overlay covers between 35% and 50% of the build area.
